(19) United States
(12) Patent Application Publication
(10) Pub. No.: US 2013/0106759 A1
(43) Pub. Date: May 2, 2013

(54) Narrow-Band Touch Detection

(71) Applicants: Einar Fredriksen, Trondheim (NO); Vemund Kval Bakken, Menlo Park, CA (US)

(72) Inventors: Einar Fredriksen, Trondheim (NO); Vemund Kval Bakken, Menlo Park, CA (US)

(21) Appl. No.: 13/283,131

(22) Filed: Oct. 27, 2011

(51) Int. Cl. G06F 3/044

(52) U.S. Cl. 345/174

(57) ABSTRACT

In one embodiment, a method includes generating a first drive signal for transmission to one or more drive lines of a capacitive touch sensor. The first drive signal comprising a function pattern with a first predetermined frequency. The method also includes receiving a sense signal from one or more sense lines of the touch sensor. The sense signal results at least in part from charge transfer driven by the first drive signal. The method also includes, by a bandpass filter with a first center frequency substantially synchronized to the first predetermined frequency, filtering out components of the sense signal outside a range of the first center frequency; and communicating from the bandpass filter to a processor a passband signal that comprises components of the sense signal within the range of the first center frequency.

### TECHNICAL FIELD

This disclosure generally relates to detecting an interaction with an object.

### BACKGROUND

An array of conductive drive and sense electrodes may form a mutual-capacitance touch sensor having one or more capacitive nodes. An intersection of a drive electrode and a sense electrodes in the array may form a capacitive node. At the intersection, the drive and sense electrodes may come near each other, but they do not make electrical contact with each other. Instead, the sense electrode is capacitively coupled to the drive electrode. A pulsed or alternating voltage applied to the drive electrode may induce a charge on the sense electrode, and the amount of charge induced may be susceptible to external influence (such as a touch by or the proximity of an object). When an object touches or comes within proximity of the drive and sense electrodes, a change in capacitance may occur at that capacitive node and a controller may measure the change in capacitance as a change in voltage. By measuring changes in voltage throughout the array, the controller may determine the position of the touch or proximity on the touch sensor.

An array of conductive electrodes of a single type (e.g. drive) may form a self-capacitance touch sensor. Each of the conductive electrodes in the array may form a capacitive node, and, when an object touches or comes within proximity of the electrode, a change in self-capacitance may occur at that capacitive node and a controller may measure the change in capacitance as a change in voltage or a change in the amount of charge needed to raise the voltage by a pre-determined amount. As with a mutual-capacitance touch screen, by measuring changes in voltage throughout the array, the controller may determine the position of the touch or proximity on the touch sensor.

In a touch-sensitive display application, a touch sensor may enable a user to interact directly with what is displayed on a display underneath the touch sensor, rather than indirectly with a mouse or touchpad. A touch sensor may be attached to or provided as part of, for example, a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

### BRIEF DESCRIPTION OF THE DRAWINGS

FIG. 1 illustrates an example system for touch detection with a bandpass filter.

FIG. 2 illustrates an example system for touch detection with a mixer.

FIG. 3 illustrates example waveforms for the example system of FIG. 1.

FIG. 4 illustrates an example method for touch detection.

### DESCRIPTION OF EXAMPLE EMBODIMENTS

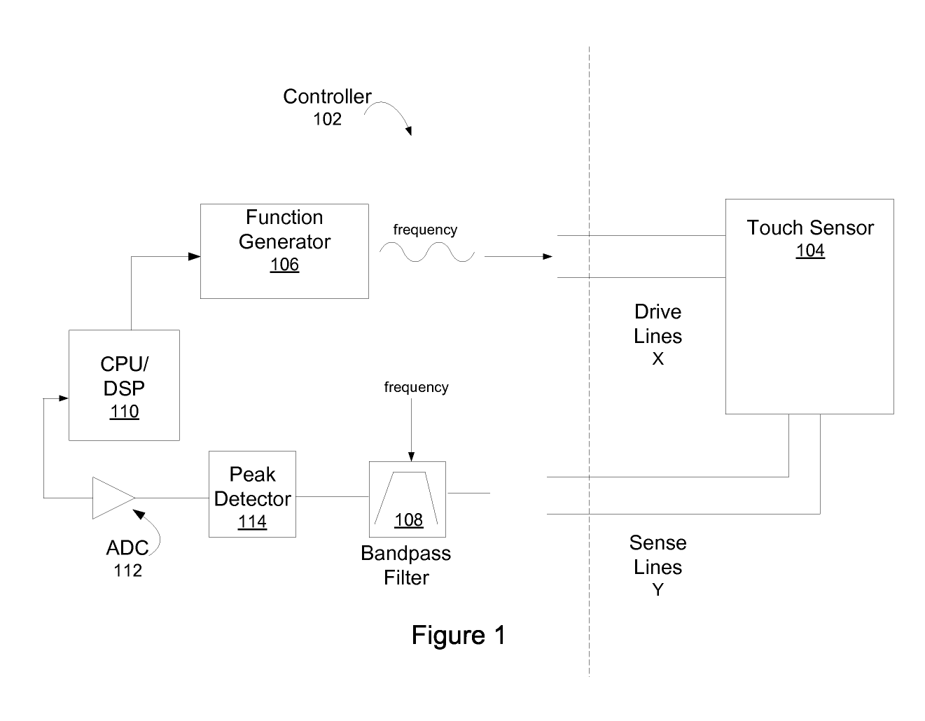

FIG. 1 illustrates an example system 100 for narrow-band capacitive touch detection with a bandpass filter. In the example of FIG. 1, system 100 includes a controller 102 (which may be a microcontroller) and a touch sensor 104. Controller 102 includes a drive-line function generator 106, a bandpass filter 108, a processing unit 110, an amplitude detector 114, and an analog-to-digital converter (ADC) 112. Although this disclosure describes and illustrates a particular arrangement of particular components for system 100, this disclosure contemplates any suitable arrangement of any suitable components for system 100.

[10] Controller 102 may be coupled to touch sensor 104 through one or more sense lines Y and one or more drive lines X. In particular embodiments, touch sensor 104 may be a mutual-capacitance touch sensor 104 that includes an array of drive electrodes and sense electrodes coupled to one of corresponding drive lines X and sense lines Y, respectively. Each intersection of a drive electrode and sense electrode forms a capacitive node. In other particular embodiments, the touch sensor may be a self-capacitance touch sensor. The self-capacitance touch sensor includes one or more electrodes each coupled to one of corresponding sense line Y. Self-capacitance touch sensor detects a presence of an object as an interaction between an object (not shown) and an electric field generated by one or more electrodes of self-capacitance touch sensor.

Controller 102 may detect and process a change in capacitance to determine the presence and location of a touch or proximity input. Controller 102 may then communicate information about the touch or proximity input to one or more other components (such one or more central processing units (CPU) or digital signal processors (DSP)) of a device, which may respond to the touch or proximity input by initiating a function of the device (or an application running on the device) associated with it. Controller 102 may be one or more integrated circuits (ICs), such as for example general-purpose microprocessors, microcontrollers, programmable logic devices or arrays, application-specific ICs (ASICs). Although this disclosure describes and illustrates a particular controller in the example system, this disclosure contemplates any suitable controller in the example system.

Drive-line function generator 106 may be configured to communicate a drive signal to touch sensor 104 through drive lines X. In particular embodiments, the drive signal may be a function pattern, e.g., trapezoid or sinusoid, with an associated frequency. A trapezoidal function pattern may utilize a slew rate limiter (not shown), while a sinusoidal pattern may prevent the function pattern from causing harmonic distortion. In other particular embodiments, Drive-line function generator 106 may be configured to modify the frequency associated with the generated function pattern.

The drive signal may induce charge on one or more sense electrodes. The amount of charge induced on one or more sense electrodes may be susceptible to external influence (such as a touch by, the proximity of an object, or noise sources). Example noise sources may comprise radiation sources or electrical chargers that emit signals over a relatively wide spectrum of frequencies during charging. As an example and not by way of limitation, power chargers for smart phones may introduce noise to touch sensor 104 of a smart phone during charging. Additional induced charge from noise sources may corrupt the signal indicative of the change in capacitance on sense lines Y of touch sensor 104. In some cases, noise on the signal indicative of the change in capacitance may register a false “touch” indicating an interaction between touch sensor 104 and an object regardless of whether the object is actually present.

Bandpass filter 108 may be coupled to touch sensor 104 through sense lines Y. Signals from touch sensor 104 may be transmitted to bandpass filter 108 through sense lines Y. As discussed above, an output signal from touch sensor 104 may include the signal indicative of the change in capacitance with a frequency associated with the function pattern, as well as a wide-band noise component. Bandpass filter 108 may be configured to pass components of an input signal within a range centered about a center frequency or passband, while attenuating components of the signal outside the passband. As an example and not by way of limitation, the center frequency may be determined by a configuration of a resistor/capacitor array or a switch cap filter of bandpass filter 108. In particular embodiments, bandpass filter 108 may have a programmable passband. Bandpass filter 108 may be configured to synchronize the center frequency with a drive-line function pattern frequency. By attenuating components of the signal outside the passband of bandpass filter 108, components of example system 100 downstream of bandpass filter 108 may receive a substantially noise-free passband signal indicative of the change in capacitance of touch sensor 104.

Amplitude detector 114 may be coupled to an output of bandpass filter 108. The output of bandpass filter 108 may include components of the passband signal from touch sensor 104 within a range of the center frequency of bandpass filter 108. Amplitude detector 114 may sample the passband signal from bandpass filter 108 and communicate a voltage corresponding to a peak amplitude of the passband signal. Amplitude detector 114 may also store the peak amplitude, and if the amplitude of the passband signal increases above the stored peak amplitude, the output voltage of amplitude detector 114 may increase to the new peak amplitude. In particular embodiments, amplitude detector 114 may include a diode coupled in series with a capacitor. In other particular embodiments, the peak voltage of the passband signal may be an indicator of a quality of the passband signal. Although this disclosure describes and illustrates a particular arrangement of particular components for amplitude detector 114, this disclosure contemplates any suitable arrangement of any suitable components for amplitude detector 114.

Analog-to-digital converter 112 may be configured to receive and sample the peak amplitude of the passband signal from amplitude detector 114. ADC 112 quantizes the analog signal from amplitude detector 112 to generate a digital representation of the analog signal. Processing unit 110 receives the digital representation of the signal from ADC 112. Processing unit 110 may be configured to filter or further process, e.g., shape, the digital representation from ADC 112. Processing unit 110 may be further configured to control generation of the function pattern by drive-line function generator 106 or program the center frequency of bandpass filter 118. In particular embodiments, a signal from processing unit 110 may configure a resistor/capacitor array or a switching frequency of a switch cap filter to program the center frequency of bandpass filter 108. In other particular embodiments, processing unit 110 may include a CPU or DSP configured to process the digital representation from ADC 112 or control generation of the function pattern by drive-line function generator 106.

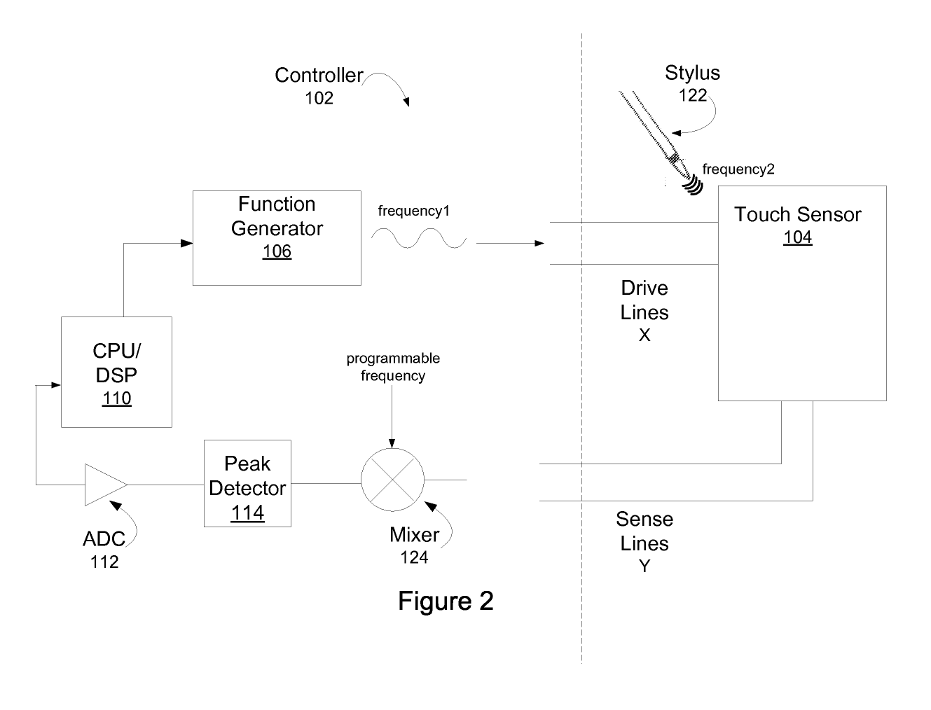

FIG. 2 illustrates an example system 120 for narrow-band capacitive touch detection with a mixer and stylus. In the example of FIG. 2, example system 120 may be configured as illustrated in FIG. 1, except substituting the bandpass filter with a mixer 124 coupled to one or more sense lines Y of touch sensor 104. As discussed above, drive-line function generator 106 generates and transmits a function pattern at an associated frequency to touch sensor 104 through one or more drive lines X. A signal having the frequency associated with the drive-line function pattern and indicative of the change in capacitance may be received by mixer 124 through sense lines Y. Mixer 124 may multiply components of the signal indicative of the change in capacitance within a range centered about a frequency of a periodic signal transmitted to a local oscillator (LO) port of mixer 124. Mixer 124 may either upconvert or downconvert the frequency of the signal indicative of the change in capacitance according to the frequency of the periodic signal communicated to the LO port. Downconverting the frequency of the signal indicative of the change in capacitance may substantially attenuate frequency components outside the range of the frequency communicated to the LO port of mixer 124 and reduce a frequency bandwidth of the signal communicated to processing unit 110. Reducing the frequency bandwidth of the signal communicated to processing unit 110 may lead to a lower ADC sampling frequency.

In particular embodiments, the periodic signal transmitted to mixer 124 may be synchronized with the drive-line function pattern generated by drive-line function generator 106. As an example and not by way of limitation, the drive-line function pattern may be simultaneously transmitted to mixer 124 and drive lines X. Components of the signal outside the passband, defined by the periodic signal transmitted to mixer 124, may be substantially attenuated.

stylus 122 may provide input to touch sensor 104. In particular embodiments, stylus 122 may be an “active” stylus 122 configured to generate a function pattern with an associated frequency. The function pattern of the stylus 122 may interact with touch sensor 104 through capacitive coupling between the stylus 122 and capacitive nodes of touch sensor 104. The frequency of the function pattern generated by stylus 122 may be different than the associated frequency of the function drive-line function pattern. The function pattern generated by stylus 122 may induce an output signal having a frequency associated with the stylus 122 function pattern and indicative of a change in capacitance caused by interaction between touch sensor 104 and stylus 122. Processing unit 110 may configure drive-line function generator 106 to transmit a periodic signal with the stylus 122 function pattern frequency to mixer 124. Since the frequency of the function generator 106 function pattern may be different than the frequency of the stylus 122 function pattern, mixer 124 may separate signals caused by interaction between touch sensor 104 and stylus 122 from signals caused by interaction between touch sensor 104 and an object based on the frequency transmitted to mixer 124. Therefore, signals caused by interaction between touch sensor 104 and stylus 122 may be detected by amplitude detector 114 without synchronization between stylus 122 and touch sensor 104 or processing unit 110. In particular embodiments, processing unit 110 may instruct drive-line function generator 106 to alternately transmit the periodic signal corresponding to the stylus 122 function pattern and the periodic signal corresponding to the drive-line function pattern. Processing unit 110 may receive input from either stylus 122 or an object (e.g., finger) and mixer 124 may filter out each input based on the frequency of the periodic signal at a given time.

In other particular embodiments, each drive line X of touch sensor 104 may receive a drive-line function pattern with a unique frequency transmitted by drive-line function generator 106 over a relatively short period of time. A periodic signal having each of the unique frequencies of the drive-line function patterns may be transmitted to mixer 124 and the signal from all sense lines Y may be scanned simultaneously. By adjusting the passband of mixer 124 to each unique frequency, controller 102 may differentiate each a passband signal component associated with each sense line Y. Simultaneously scanning all sense lines Y may significantly decrease the scan time of example system 120.

As described above, amplitude detector 114 may receive a filtered signal from mixer 124 containing components from the interaction between touch sensor 104 and an object or a component from interaction between touch sensor 104 and stylus 122. Amplitude detector 114 may sample the passband signal and transmit the peak amplitude of passband signal to ADC 112. The filtered signal from mixer 124 may be converted to a digital representation by ADC 112 and the digital representation transmitted to processing unit 110 for processing.

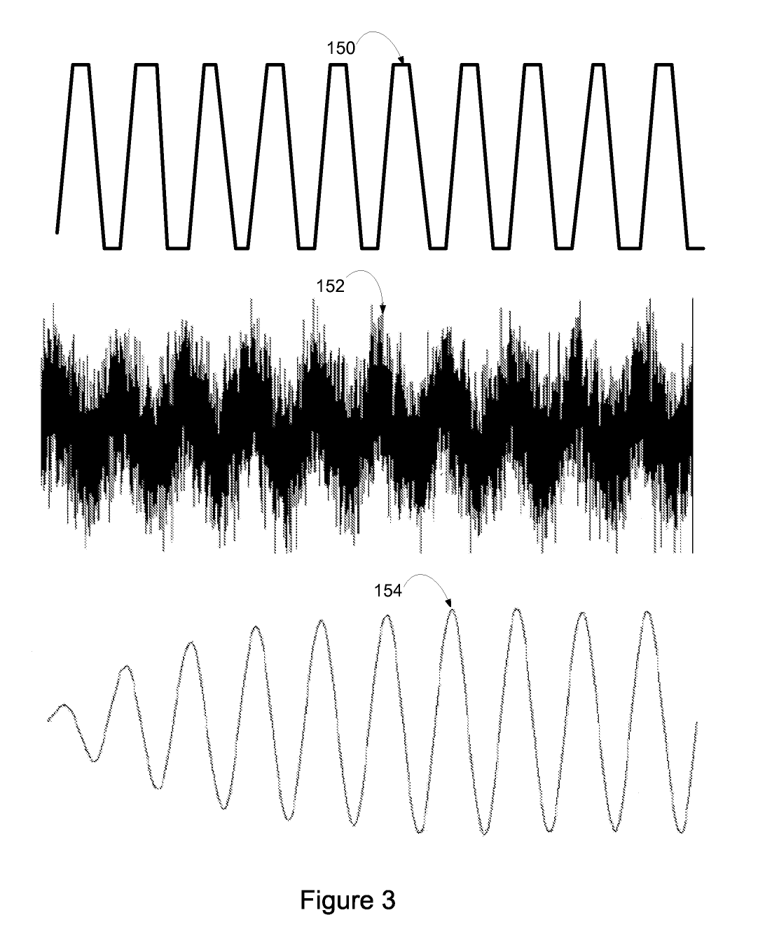

FIG. 3 illustrates example waveforms for the example system of FIG. 1. In the example of FIG. 3, example waveforms include drive-line signal 150, signal on the sense lines 152, and passband signal 154. As described above, the drive-line function generator may generate and transmit a drive signal 150 to drive lines of the touch sensor. In particular embodiments, the center frequency of the bandpass filter may be synchronized with the frequency of the drive signal 150. The signal on the sense lines 152 of the touch sensor may include a component from indicative change in capacitance caused by interaction between touch sensor and an object, as well as a noise component due to a relatively broad-spectrum noise from one or more noise sources. In particular embodiments, signal on the sense lines 152 may contain a component from an active stylus with an associated frequency different than the frequency of drive signal 150. As described above, signal on the sense lines 152 may be transmitted to the bandpass filter of the example system of FIG. 1. Components of the received signal on the sense lines 152 outside a range centered defined by the center frequency of the bandpass filter may be attenuated. As a result, a passband signal 154 from the bandpass filter may substantially reduce components of noise outside the center frequency of the bandpass filter. In particular embodiments, passband signal 154 may be used to differentiate between input provided by an object (e.g., finger) at one frequency from input provided by an active stylus at another frequency. Although this disclosure describes and illustrates example waveforms for a particular arrangement of particular components in the example system of FIG. 1, the example waveforms are applicable to the example system of FIG. 2.

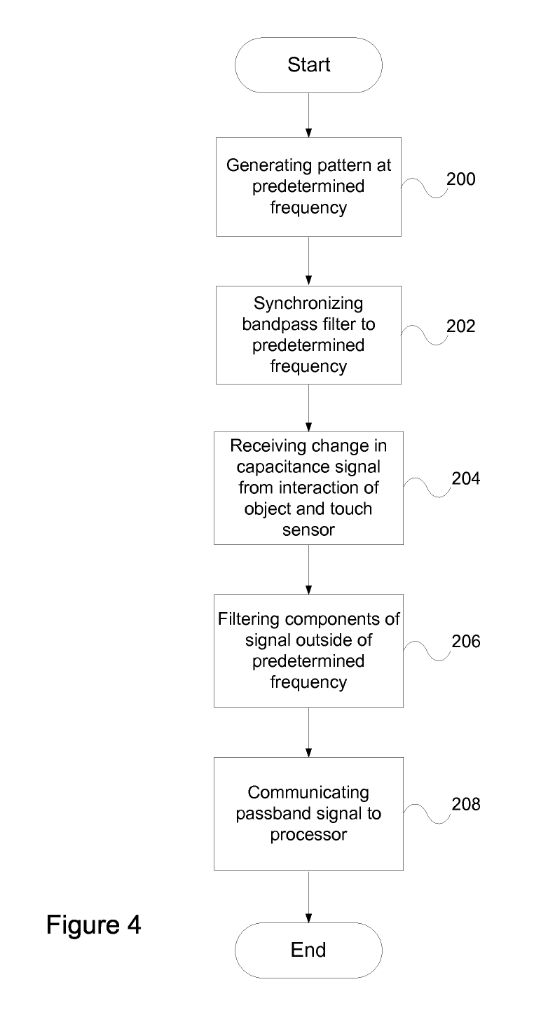

FIG. 4 illustrates an example method for narrow-band touch detection. The method may start at step 200, where a function pattern may be generated at a predetermined frequency. In particular embodiments, the function pattern may be a sinusoidal pattern generated by a function generator and transmitted to a touch sensor. In step 202, a center frequency of the bandpass filter may be synchronized to the predetermined frequency of the function pattern. In particular embodiments, the predetermined frequency may be transmitted to the bandpass filter.

In other particular embodiments, the bandpass filter may be synchronized to another predetermined frequency in response to noise at the initial predetermined frequency. Step 204 receives a change of capacitance signal from an interaction between an object and the touch sensor. In particular embodiments, the interaction may be capacitive coupling between a stylus transmitting a function pattern at a second predetermined frequency and the touch sensor. In other particular embodiments, the change of capacitance signal includes components introduced by a noise source. At step 206, components of the signal outside the predetermined frequency may be filtered. In particular embodiments, a passband of the bandpass filter may be defined through the predetermined frequency of the drive-line function pattern or the predetermined frequency of the stylus function pattern. In other particular embodiments, filtering may be through a periodic signal predetermined frequency transmitted to a mixer coupled to the sense lines of the touch sensor. At step 208, the passband signal may be communicated to a processor, at which point the method may end. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components carrying out particular steps of the method of FIG. 4, this disclosure contemplates any suitable combination of any suitable components carrying out any suitable steps of the method of FIG. 4.

Herein, reference to a computer-readable storage medium encompasses one or more non-transitory, tangible computer-readable storage media possessing structure. As an example and not by way of limitation, a computer-readable storage medium may include a semiconductor-based or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
generating a first drive signal for transmission to one or more drive lines of a capacitive touch sensor, the first drive signal comprising a function pattern with a first predetermined frequency;
receiving a sense signal from one or more sense lines of the touch sensor, the sense signal resulting at least in part from charge transfer driven by the first drive signal;
by a bandpass filter with a first center frequency substantially synchronized to the first predetermined frequency, filtering out components of the sense signal outside a range of the first center frequency; and
communicating from the bandpass filter to a processor a passband signal that comprises components of the sense signal within the range of the first center frequency.

2. The method of claim 1, wherein the first predetermined frequency is programmable and the first center frequency is adjustable.

3. The method of claim 1, further comprising sampling an amplitude of the passband signal to determine a quality of the bandpass signal.

4. The method of claim 3, further comprising quantifying the amplitude of the passband signal into a digital representation for the sampling.

5. The method of claim 1, wherein the bandpass filter is implemented using a mixer.

6. The method of claim 1, further comprising:
receiving another sense signal resulting at least in part from charge transfer driven by a second drive signal from a stylus, the second drive signal comprising a function pattern with a second predetermined frequency; and
by the bandpass filter with a second center frequency substantially synchronized to the second predetermined frequency, filtering out components of the other sense signal outside a range of the second center frequency.

7. The method of claim 6, further comprising decoupling components of the sense signal within the range of the first center frequency from components of the other sense signal within the range of the second center frequency.

8. One or more computer-readable non-transitory storage media embodying logic that is configured when executed to:
generate a first drive signal for transmission to one or more drive lines of a capacitive touch sensor, the drive signal comprising a function pattern with a first predetermined frequency;
receive a sense signal from one or more sense lines of the touch sensor, the sense signal resulting at least in part from charge transfer driven by the first drive signal;
by a bandpass filter with a first center frequency substantially synchronized to the first predetermined frequency, filter out components of the sense signal outside a range of the first center frequency; and
communicate from the bandpass filter to a processor a passband signal that comprises components of the sense signal within the range of the first center frequency.

9. The media of claim 8, wherein the first predetermined frequency is programmable and the first center frequency is adjustable.

10. The media of claim 8, wherein the logic is further configured to sample an amplitude of the passband signal to determine a quality of the bandpass signal.

11. The media of claim 10, wherein the logic is further configured to quantify the amplitude of the passband signal into a digital representation for the sampling.

12. The media of claim 8, wherein the bandpass filter is implemented using a mixer.

13. The media of claim 8, wherein the logic is further configured to:
receive another sense signal resulting at least in part from charge transfer driven by a second drive signal from a stylus, the second drive signal comprising a function pattern with a second predetermined frequency; and
by the bandpass filter with a second center frequency substantially synchronized to the second predetermined frequency, filter out components of the other sense signal outside a range of the second center frequency.

14. The media of claim 13, wherein the logic is further configured to decouple components of the sense signal within the range of the first center frequency from components of the other sense signal within the range of the second center frequency.

15. A device comprising:
a capacitive touch sensor; and
one or more computer-readable non-transitory storage media embodying logic that is configured when executed to:
generate a first drive signal for transmission to one or more drive lines of a capacitive touch sensor, the drive signal comprising a function pattern with a first predetermined frequency;
receive a sense signal from one or more sense lines of the touch sensor, the sense signal resulting at least in part from charge transfer driven by the first drive signal;
by a bandpass filter with a first center frequency substantially synchronized to the first predetermined frequency, filter out components of the sense signal outside a range of the first center frequency; and
communicate from the bandpass filter to a processor a passband signal that comprises components of the sense signal within the range of the first center frequency.

16. The device of claim 15, wherein the first predetermined frequency is programmable and the first center frequency is adjustable.

17. The device of claim 15, wherein the logic is further configured to sample an amplitude of the passband signal to determine a quality of the bandpass signal.

18. The device of claim 17, wherein the logic is further configured to quantify the amplitude of the passband signal into a digital representation for the sampling.

19. The device of claim 15, wherein the logic is further configured to:
receive another sense signal resulting at least in part from charge transfer driven by a second drive signal from a stylus, the second drive signal comprising a function pattern with a second predetermined frequency; and
by the bandpass filter with a second center frequency substantially synchronized to the second predetermined frequency, filter out components of the other sense signal outside a range of the second center frequency.

20. The device of claim 19, wherein the logic is further configured to decouple components of the sense signal within the range of the first center frequency from components of the other sense signal within the range of the second center frequency.
